(19) United States
(12) Patent Application Publication
(10) Pub. No.: US 2026/0263920 A1
(43) Pub. Date: Sep. 10, 2026

(54) OPERATION DEVICE

(71) Applicant: Sony Interactive Entertainment Inc., Tokyo (JP)

(72) Inventor: Naoki Ogishita, Tokyo (JP)

(21) Appl. No.: 19/658,249

(22) Filed: Apr. 24, 2026

Related U.S. Application Data
(63) Continuation of application No. PCT/JP2023/038890, filed on Oct. 27, 2023.

(51) Int. Cl. A63F 13/24

(52) U.S. Cl. CPC A63F 13/24

(57) ABSTRACT

An operation device to be used while being fixed to a mobile device including a display screen includes a right-hand unit configured to be gripped and used by a user with their right hand, a left-hand unit configured to be gripped and used by a user with their left hand, and a cord-shaped member having flexibility and coupled to both the right-hand unit and the left-hand unit. The right-hand unit includes an abutment portion configured to abut against one side surface of the mobile device, and the left-hand unit includes an abutment portion configured to abut against a side surface of the mobile device on an opposite side to the one side surface.

### CROSS-REFERENCE TO RELATED APPLICATIONS

This application is a continuation of International Application No. PCT/JP2023/038890, filed October 27, 2023. This disclosure of the prior application is considered part of the disclosure of this application

### TECHNICAL FIELD

The present specification relates to an operation device utilized for operation input to an information processing device.

### BACKGROUND

In a case in which a user plays a video game, for example, the user desirably utilizes an operation device including an operation member suitable for operations to be performed by the user. A home game console, for example, is therefore provided with a dedicated operation device suitable for operation thereof.

### SUMMARY

A mobile device including a display screen, such as a smartphone or a tablet terminal, has a relatively small screen size, and thus the user may want to utilize the mobile device while holding the mobile device in their hands. In this case, it is difficult for the user to perform an operation input while holding the operation device separate from the mobile device with their hands.

The present specification has been made in view of the above-described circumstances, and an object thereof is to provide an operation device that can be utilized together with a mobile device including a display screen.

An operation device according to an aspect of the present specification is an operation device to be used while being fixed to a mobile device including a display screen. The operation device includes a right-hand unit configured to be gripped and used by a user with their right hand, a left-hand unit configured to be gripped and used by a user with their left hand, and a cord-shaped member having flexibility and coupled to both the right-hand unit and the left-hand unit. The right-hand unit includes an abutment portion configured to abut against one side surface of the mobile device, and the left-hand unit includes an abutment portion configured to abut against a side surface of the mobile device on an opposite side to the one side surface.

### BRIEF DESCRIPTION OF DRAWINGS

FIG. 1 is a perspective view illustrating an example of an outer appearance of an operation device according to an implementation of the present specification.

FIG. 2 is a perspective view illustrating the operation device in a state fixed to a mobile device as viewed from a front-surface side.

FIG. 3 is a perspective view illustrating the operation device in a state fixed to the mobile device as viewed from a back-surface side.

FIG. 4 is a diagram illustrating the operation device in a state fixed to the mobile device as viewed from a side surface.

FIG. 5 is a diagram illustrating an example of an attachment for coupling a right-hand unit and a left-hand unit.

FIG. 6 is a diagram illustrating a state in which the right-hand unit and the left-hand unit are coupled via the attachment illustrated in FIG. 5.

FIG. 7 is a diagram illustrating a state in which the right-hand unit and the left-hand unit are coupled by an attachment including a slide pad.

FIG. 8 is a diagram illustrating a state in which the right-hand unit and the left-hand unit are directly coupled.

FIG. 9 is a diagram illustrating an example of a unit including a plug connector.

### DETAILED DESCRIPTION

Hereinafter, implementations of the present specification will be described in detail with reference to the drawings.

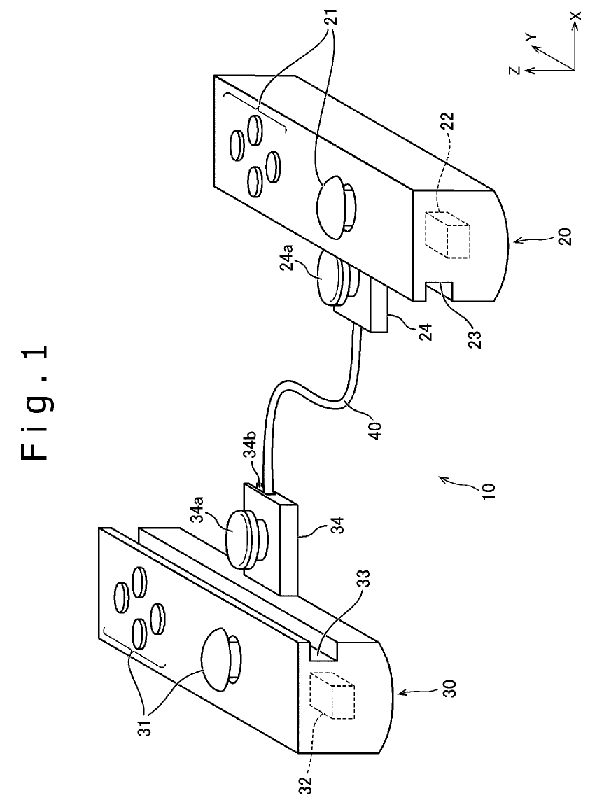

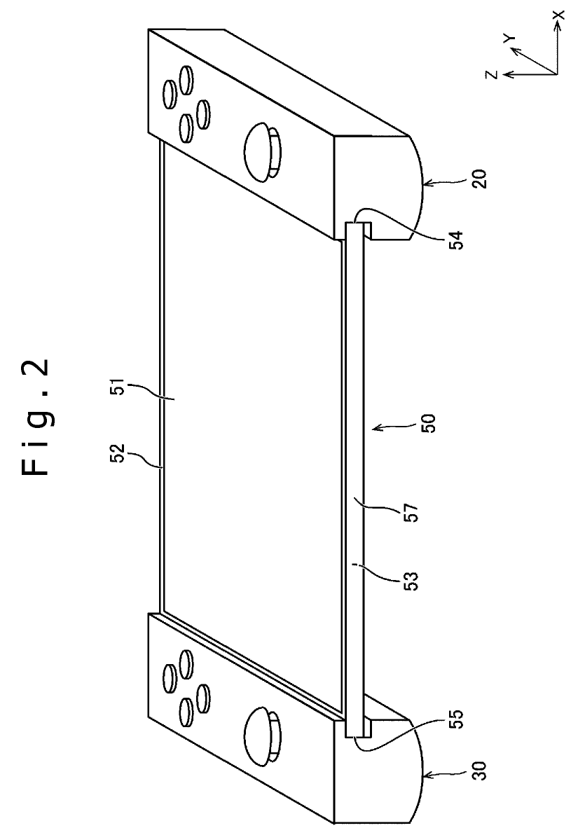

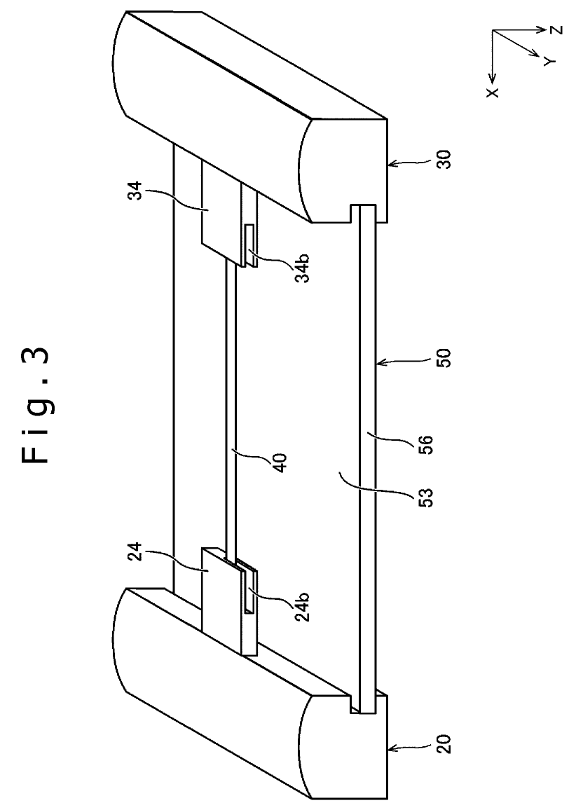

FIG. 1 is a perspective view illustrating an example of an outer appearance of an operation device 10 according to an implementation of the present specification. The operation device 10 according to the present implementation is used in a state of being fixed to an information processing device 50 of a mobile type in order for a user to perform an operation input to the information processing device 50. FIGS. 2 and 3 are diagrams illustrating the operation device 10 according to the present implementation in a state of being fixed to and used with the information processing device 50, FIG. 2 illustrating a state as viewed from a front-surface side (side on which display screen is disposed), and FIG. 3 illustrating a state as viewed from a back-surface side (opposite side to front-surface side).

The information processing device 50 is a mobile terminal device having a substantially rectangular, flat plate shape, such as a smartphone or a tablet terminal, and includes a display screen 51 having a substantially rectangular shape on one surface thereof. In the following description, in a case in which the user utilizes the information processing device 50 together with the operation device 10, the information processing device 50 displays an image presented to the user in an orientation in which a longitudinal direction of the display screen 51 is a horizontal direction (landscape display). Further, hereinafter, for convenience of description, the longitudinal direction (horizontal direction) of the display screen 51 is designated as an X-axis direction, a short direction (vertical direction) is designated as a Y-axis direction, and a thickness direction of the information processing device 50 is designated as a Z-axis direction. Furthermore, a surface on which the display screen 51 of the information processing device 50 is disposed (surface on positive side in Z-axis direction) is referred to as a front surface 52, and a surface on an opposite side thereto (surface on negative side in Z-axis direction) is referred to as a back surface 53. Further, of four side surfaces as viewed from the user facing the display screen 51, a side surface on a right side (surface on positive side in X-axis direction) is referred to as a right-side surface 54, a side surface on a left side on an opposite side thereto (surface on negative side in X-axis direction) is referred to as a left-side surface 55, a side surface on an upper side (surface on positive side in Y-axis direction) is referred to as an upper-side surface 56, and a side surface on a lower side (surface on negative side in Y-axis direction) on an opposite side thereto is referred to as a lower-side surface 57.

As illustrated in FIG. 1, the operation device 10 includes a right-hand unit 20, a left-hand unit 30, and a cord-shaped member 40. In the present implementation, in a state in which the right-hand unit 20 and the left-hand unit 30 are fixed to the information processing device 50, the user can grip and use the right-hand unit 20 and the left-hand unit 30 with their right hand and left hand, respectively.

The right-hand unit 20 is an operation unit utilized by being gripped by the user with their right hand and includes an operation member 21, a communication interface 22, an abutment portion 23, and a coupling portion 24.

The operation member 21 is a member by which the user performs various operation inputs to the information processing device 50 and may include various operation members such as an operation button and a tilting operation member. The operation member 21 is disposed at a position enabling operation by a thumb, an index finger, or the like of the right hand while the user grips the right-hand unit 20 with their right hand. Note that, although the operation member 21 is disposed only on a front-surface side of the right-hand unit 20 in FIG. 1, the operation member 21 is not limited thereto and may be disposed on another surface such as a side surface or a back surface.

The communication interface 22 is an interface for transmitting, to the information processing device 50, an operation signal indicating content of the operation input by the user to the operation member 21. In the present implementation, the communication interface 22 is a wireless communication interface that directly transmits the operation signal to the information processing device 50 by wireless communication such as Bluetooth (registered trademark), for example.

The abutment portion 23 is formed on a left-side surface of the right-hand unit 20 so as to abut against the right-side surface 54 of the information processing device 50. As described in detail below, when the user utilizes the operation device 10, the right-hand unit 20 is fixed with the abutment portion 23 abutting against the right-side surface 54 of the information processing device 50.

The coupling portion 24 is disposed on the back-surface side of the right-hand unit 20 and is coupled in a state such that the cord-shaped member 40 described below does not readily detach.

The left-hand unit 30 is an operation unit utilized by being gripped by the user with their left hand and includes an operation member 31, a communication interface 32, an abutment portion 33, and a coupling portion 34. Note that the left-hand unit 30 is configured substantially bilaterally symmetrical to the right-hand unit 20 in overall shape.

The operation member 31 is a member by which the user performs various operation inputs to the information processing device 50 and may include various operation members, as with the operation member 21. The operation member 31 is disposed at a position enabling operation by a thumb, an index finger, or the like of the left hand while the user grips the left-hand unit 30 with their left hand. The operation member 31, similarly, may be disposed not only on a front-surface side of the left-hand unit 30, but also on another surface, such as a side surface or a back surface. Further, the operation member 31 may differ in type, number, arrangement, and the like from the operation member 21 disposed in the right-hand unit 20.

The communication interface 32 is an interface for transmitting, to the information processing device 50, operation data indicating content of the operation input by the user to the operation member 31. In the present implementation, the communication interface 32 directly transmits the operation data to the information processing device 50 by wireless communication, similarly to the communication interface 22.

The abutment portion 33 is formed on a right-side surface of the left-hand unit 30 so as to abut against the left-side surface 55 of the information processing device 50 (side surface on opposite side to right-side surface 54 against which abutment portion 23 of right-hand unit 20 abuts). When the user utilizes the operation device 10, the left-hand unit 30 is fixed in a state in which the abutment portion 33 abuts against the left-side surface 55 of the information processing device 50.

The coupling portion 34 is disposed on the back-surface side of the left-hand unit 30 and is coupled in a state such that the cord-shaped member 40 described below does not readily detach.

The cord-shaped member 40 is a member formed of a flexible material having a long, narrow shape, and one end portion thereof is coupled to the coupling portion 24 of the right-hand unit 20. Further, an end portion on an opposite side to the side coupled to the right-hand unit 20 is coupled to the coupling portion 34 of the left-hand unit 30. That is, the right-hand unit 20 and the left-hand unit 30 are separate and independent housings but are coupled to each other via the cord-shaped member 40. The coupling portion 24 of the right-hand unit 20 and the coupling portion 34 of the left-hand unit 30 are disposed on the back-surface sides of the respective units and thus, when the right-hand unit 20 and the left-hand unit 30 are fixed to the information processing device 50, the cord-shaped member 40 is disposed on the back surface 53 side of the information processing device 50 as illustrated in FIG. 3, so as not to hinder the user from viewing the display screen 51 of the information processing device 50.

Furthermore, in the present implementation, the cord-shaped member 40 is formed of a material having elasticity, such as rubber, and a length thereof extends and contracts. The length of the cord-shaped member 40 is thus variable, enabling the operation device 10 according to the present implementation to be fixed to and used with a plurality of types of information processing device 50 having different sizes.

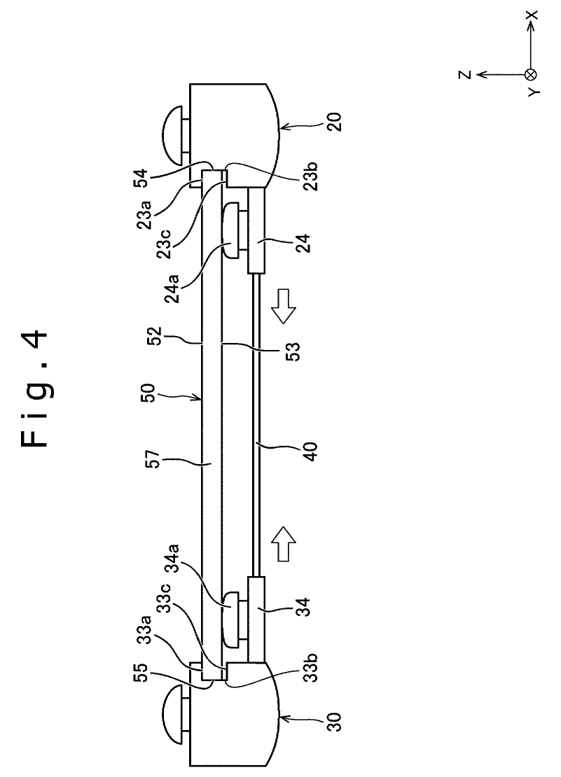

Hereinafter, examples of shapes of the abutment portions 23 and 33 for fixing the operation device 10 according to the present implementation to the information processing device 50 will be described with reference to FIG. 4. FIG. 4 schematically illustrates the information processing device 50 as viewed from the lower-side surface 57 side (that is, from negative side in Y-axis direction).

In this example, a portion of the left-side surface of the right-hand unit 20 is formed in a U shape opening toward the information processing device 50 (negative side in X-axis direction) as viewed from the Y-axis direction, thereby forming a groove extending in the Y-axis direction. This groove functions as the abutment portion 23. Hereinafter, three surfaces constituting side surfaces of the U shape functioning as the abutment portion 23 are referred to as a surface 23a, a surface 23b, and a surface 23c. Here, the surface 23a is a surface oriented toward the negative side in the Z-axis direction, the surface 23b is a surface oriented toward the negative side in the X-axis direction, and the surface 23c is a surface oriented toward the positive side in the Z-axis direction.

The abutment portion 33 of the left-hand unit 30 is formed substantially bilaterally symmetrical to the abutment portion 23 of the right-hand unit 20. That is, a portion of the right-side surface of the left-hand unit 30 is formed in a U shape opening toward the information processing device 50 (positive side in X-axis direction) as viewed from the Y-axis direction, thereby forming a groove extending in the Y-axis direction. This groove functions as the abutment portion 33. Hereinafter, three surfaces constituting side surfaces of the U shape functioning as the abutment portion 33 are referred to as a surface 33a, a surface 33b, and a surface 33c. The surface 33a is a surface oriented toward the negative side in the Z-axis direction, the surface 33b is a surface oriented toward the positive side in the X-axis direction, and the surface 33c is a surface oriented toward the positive side in the Z-axis direction.

In a case in which the operation device 10 is attached to the information processing device 50, a right-end portion of the information processing device 50 is inserted into a space formed by the abutment portion 23 of the right-hand unit 20, and a left-end portion of the information processing device 50 is inserted into a space formed by the abutment portion 33 of the left-hand unit 30. Here, the length of the cord-shaped member 40 with the right-hand unit 20 and the left-hand unit 30 fixed to the information processing device 50 is longer than the length (natural length) when no force is applied. Accordingly, when the right-hand unit 20 and the left-hand unit 30 are fixed to the information processing device 50, a pulling force pulling in a center direction of the information processing device 50 is applied to each of the right-hand unit 20 and the left-hand unit 30 by the elasticity of the cord-shaped member 40. The block arrows in FIG. 4 indicate the directions of this pulling force. This pulling force causes the surface 23a of the abutment portion 23 and the surface 33a of the abutment portion 33 to abut and press against the front surface 52 of the information processing device 50, the surface 23b of the abutment portion 23 to abut and press against the right-side surface 54 of the information processing device 50, and the surface 33b of the abutment portion 33 to abut and press against the left-side surface 55 of the information processing device 50. As a result, the right-hand unit 20 and the left-hand unit 30 engage with the left and right end portions of the information processing device 50, fixing the operation device 10 to the information processing device 50.

Here, desirably, widths of the grooves functioning as the abutment portions 23 and 33 in the Z-axis direction (that is, lengths of surface 23b and surface 33b in Z-axis direction) are larger than the thickness of the information processing device 50. This enables the operation device 10 to be fixed to and used with a plurality of types of information processing device 50 having different thicknesses. Note that, although the abutment portions 23 and 33 have U shapes in a side view, the abutment portions may each have a different shape from the U shape as long as each abutment portion includes a surface that abuts against at least the front surface 52 and the corresponding side surface (right-side surface 54 or left-side surface 55) of the information processing device 50.

Furthermore, in the present implementation, the coupling portion 24 is formed protruding further leftward (toward negative side in X-axis direction) from the left-side surface on the back-surface side of the right-hand unit 20, and a projecting portion 24a protruding further frontward (toward positive side in Z-axis direction) from this protruding portion is formed. Similarly, the coupling portion 34 is formed protruding further rightward (toward positive side in X-axis direction) from the right-side surface on the back-surface side of the left-hand unit 30, and a projecting portion 34a protruding further frontward (toward positive side in Z-axis direction) from this protruding portion is formed. These projecting portions 24a and 34a are formed of a deformable material, such as rubber or sponge, on upper surfaces thereof, and have heights so as to abut against the back surface 53 of the information processing device 50 when the right-hand unit 20 and the left-hand unit 30 are fixed to the information processing device 50. Accordingly, the projecting portions 24a and 34a support the information processing device 50 from the bottom surface 53 side and thus, even when the widths of the abutment portions 23 and 33 in the Z-axis direction are larger than the thickness of the information processing device 50, the right-hand unit 20 and the left-hand unit 30 can be fixed to the information processing device 50 in a stable state without wobbling.

Further, at least portions of surfaces of the abutment portion 23 and the abutment portion 33 are preferably formed of a non-slip material, such as rubber, for example. Specifically, a portion including a location of the surface of each of the abutment portion 23 and the abutment portion 33 that directly comes into contact with the information processing device 50 is formed of a member having a relatively larger friction coefficient than those of other portions of the housing surface of each of the right-hand unit 20 and the left-hand unit 30. Accordingly, when the right-hand unit 20 and the left-hand unit 30 are fixed to the information processing device 50 by engaging the abutment portion 23 and the abutment portion 33 with the left and right end portions of the information processing device 50, it is possible to prevent a state in which each unit wobbles or is displaced relative to the information processing device 50.

Note that, as described above, in the example of this drawing, the widths of the abutment portions 23 and 33 in the Z-axis direction are larger than that of the information processing device 50, and the units are fixed to the information processing device 50 in a state in which the surfaces 23c and 33c do not come into direct contact with the information processing device 50. However, the configuration is not limited thereto and, in a case in which the thickness of the information processing device 50 is assumed to be within a certain range, the abutment portions 23 and 33 may be formed so that the units are fixed to the information processing device 50 in a state in which the surfaces 23c and 33c are in contact with the bottom surface 53 of the information processing device 50. Specifically, by forming the surfaces of the abutment portions 23 and 33 from a deformable material, such as rubber or sponge, when the right-end portion of the information processing device 50 is inserted into the abutment portion 23 and the left-end portion of the information processing device 50 is inserted into the abutment portion 33, the surfaces 23a and 33a can press against the front surface 52 of the information processing device 50, and the surfaces 23c and 33c can press against the back surface 53 of the information processing device 50. This makes it possible to support the information processing device 50 by the abutment portions 23 and 33 and fix the right-hand unit 20 and the left-hand unit 30 to the information processing device 50 in a stable state. Note that, in this case, the upper surfaces of the projecting portions 24a and 34a do not necessarily need to be brought into contact with the back surface 53 of the information processing device 50.

Further, the operation device 10 according to the present implementation may be utilizable in a state in which the right-hand unit 20 and the left-hand unit 30 are not fixed to the information processing device 50, but the two units are coupled to each other without the information processing device 50 as an intermediary and are separated and independent from the information processing device 50. This allows the user to utilize the operation device 10 for operation input to a tablet terminal, a home game console, a personal computer, an in-vehicle terminal, or the like having a size not supported by the operation device 10.

Specifically, the right-hand unit 20 and the left-hand unit 30 each include a coupling mechanism for coupling with the other. Note that the right-hand unit 20 and the left-hand unit 30 may be directly coupled to each other without using another member or may be coupled to each other by a coupling attachment separately prepared.

In the example in FIG. 1, the projecting portion 24a formed on the coupling portion 24 and the projecting portion 34a formed on the coupling portion 34 also function as a coupling mechanism for coupling the two units.

In this example, a dedicated attachment 60 is provided, and fitting portions 61 and 62 that fit with the projecting portions 24a and 34a, respectively, are provided on a lower surface of this attachment 60. The right-hand unit 20 and the left-hand unit 30 are coupled to each other via the attachment 60 by fitting the projecting portion 24a of the right-hand unit 20 to the fitting portion 61 and fitting the projecting portion 34a of the left-hand unit 30 to the fitting portion 62.

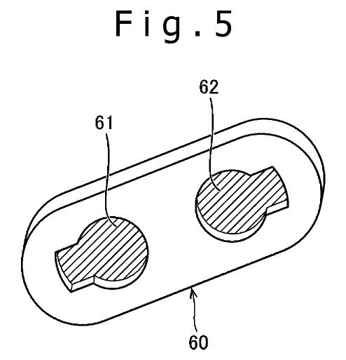

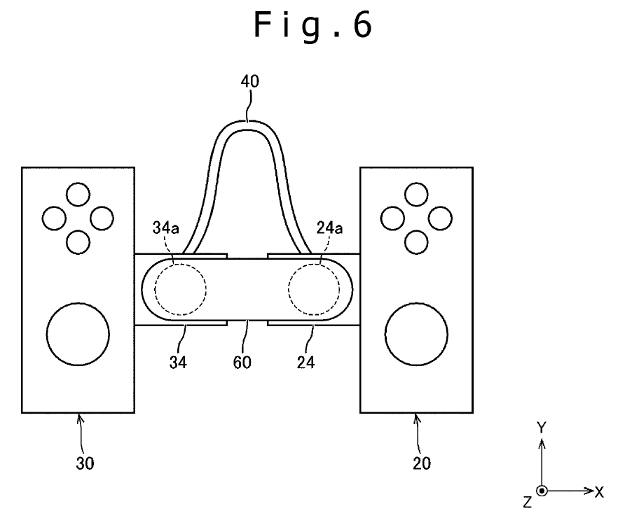

FIG. 5 is a perspective view illustrating the attachment 60 in this example as viewed from below, and FIG. 6 is a perspective view illustrating the operation device 10 in a state in which the right-hand unit 20 and the left-hand unit 30 are coupled to each other by using the attachment 60 as viewed from the front-surface side. In this example, the projecting portions 24a and 34a are configured such that portions on base-portion sides (back-surface sides) are narrower than those on tip-end sides (front-surface sides), and the fitting portions 61 and 62 are formed with holes that are partially narrowed so as to fit together with the portions of the projecting portions 24a and 34a on the base-portion sides. This makes it possible to hook the tip-end sides of the projecting portions 24a and 34a and fit the projecting portions 24a and 34a into the fitting portions 61 and 62 and thus attach the right-hand unit 20 and left-hand unit 30 to the attachment 60 so as to prevent easy detachment. Thus, the right-hand unit 20 and the left-hand unit 30 are coupled to each other, allowing the user to perform operation input to various information processing devices by using the operation device 10 alone.

Note that, in a case in which the right-hand unit 20 and the left-hand unit 30 are thus coupled to each other, a distance between the right-hand unit 20 and the left-hand unit 30 is short as compared with that in a case of being fixed to the information processing device 50, and thus it is assumed that the cord-shaped member 40 is in a slack state. Therefore, in a case in which the two units are coupled, desirably a configuration is adopted such that the cord-shaped member 40 does not get in the way. In the present implementation, as illustrated in FIG. 3 and the like, a cutout 24b opening from an upper side (positive side in Y-axis direction) to a left side of the coupling portion 24 is formed, and the cord-shaped member 40 is coupled inside this cutout 24b. Therefore, the cord-shaped member 40 is configured to extend outward in a direction in which this cutout 24b opens. Similarly, a cutout 34b opening from an upper side (positive side in Y-axis direction) to a right side of the coupling portion 34 is formed, and the cord-shaped member 40 is coupled inside the cutout 34b.

With these cutouts 24b and 34b, in a case in which the right-hand unit 20 and the left-hand unit 30 are brought close to each other, the cord-shaped member 40 extends upward (toward positive side in Y-axis direction) from both the coupling portion 24 and the coupling portion 34 as illustrated in FIG. 6, preventing the cord-shaped member 40 from hanging down toward the front side as viewed from the user.

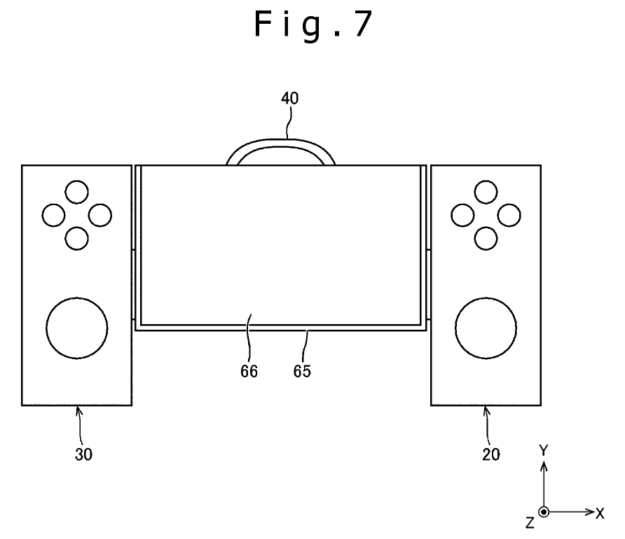

In this example in FIG. 6, the attachment 60 is used simply to couple the right-hand unit 20 and the left-hand unit 30, but the configuration is not limited thereto, and the right-hand unit 20 and the left-hand unit 30 may be coupled to an attachment including another operation member that can be used for operation input by the user. FIG. 7 illustrates an example of a case in which the right-hand unit 20 and the left-hand unit 30 are coupled by an attachment 65 including a slide pad 66 on a front surface. In this example, two fitting portions (not illustrated) similar to those in the example of the attachment 60 are disposed on a back surface of the attachment 65, and the projecting portion 24a of the right-hand unit 20 and the projecting portion 34a of the left-hand unit 30 are fitted and fixed to these fitting portions, respectively. In this case, the attachment 65 includes a wireless communication interface and transmits to the information processing device 50 through wireless communication, an operation signal indicating the content of the operation input by the user to an operation member included therein.

Further, in the description described above, the right-hand unit 20 and the left-hand unit 30 are coupled via the dedicated attachment 60 or 65, but each unit may include a coupling mechanism that can directly couple the two without the dedicated attachment.

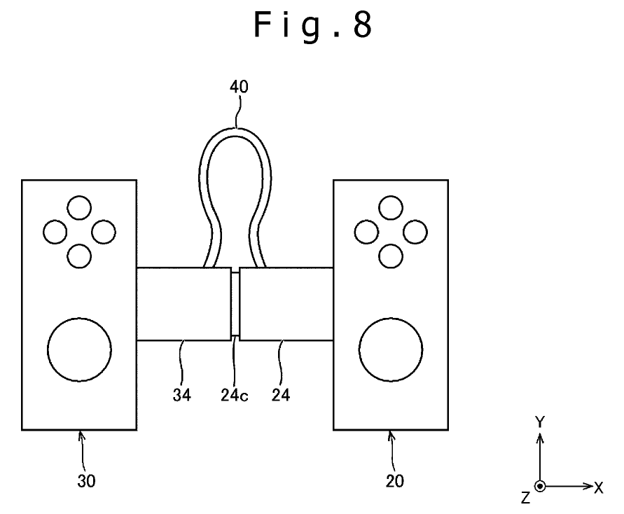

As an example, magnets may be disposed as coupling mechanisms at respective portions of the coupling portions 24 and 34 that come into contact with each other, and the right-hand unit 20 and the left-hand unit 30 may be coupled by a magnetic force of these magnets. Further, to more reliably couple the two units, a coupling mechanism such as a projecting portion formed on one of the two units and a coupling hole formed in the other into which the projecting portion can be inserted may be provided, and the two units may be coupled by fitting the two units together. FIG. 8 illustrates an example of a case in which the right-hand unit 20 and the left-hand unit 30 are coupled by such a coupling mechanism. In the example of this drawing, a projecting portion 24c provided on a left-side surface of the coupling portion 24 is inserted and fitted into a coupling hole provided in a right-side surface of the coupling portion 34, whereby the two units are coupled. In addition, the right-hand unit 20 and the left-hand unit 30 may include a coupling mechanism that couples the right-hand unit 20 and the left-hand unit 30 to each other by a desired method.

As described above, according to the operation device 10 according to the present implementation, the user can easily fix the operation device 10 to the mobile information processing device 50 that does not include a dedicated coupling mechanism corresponding to the operation device 10, and perform an operation input by using the operation device 10 while viewing the display content of the display screen 51 disposed on the information processing device 50.

Note that the implementations of the present specification are not limited to those described above. For example, in the above description, the operation device 10 is fixed to the mobile information processing device 50, but the configuration is not limited thereto, and the operation device 10 may be fixed to and used with a mobile display device separated from the information processing device and including a display screen that displays a screen generated by the information processing device. In this case as well, the user can perform an operation input to the information processing device by using the operation device 10 fixed to the display device while viewing the display screen provided in the display device.

Further, in the above description, the information processing device 50 is assumed to display an image in an orientation in which the longitudinal direction is the horizontal direction, and the right-hand unit 20 and the left-hand unit 30 are fixed to the right-side surface 54 and the left-side surface 55, respectively. However, the configuration is not limited thereto, and the operation device 10 may be used while fixed to the information processing device 50, even in a case in which the information processing device 50 displays an image in a vertical orientation (orientation with longitudinal direction as vertical direction). In this case, the user engages and fixes one of the right-hand unit 20 or the left-hand unit 30 to the upper-side surface 56 of the information processing device 50 and the other to the lower-side surface 57 on an opposite side to the upper-side surface 56.

Further, the appearance, shape, scale, operation member arrangement, and the like of the operation device 10 illustrated in the drawings are merely examples, and the operation device 10 may have various configurations without departing from the spirit of the present specification. The right-hand unit 20 and the left-hand unit 30 may each include, in respective housings, a vibration mechanism that presents vibration to the user, a force feedback presentation mechanism that presents force feedback to fingers operating the operation member, and the like.

Further, in the above description, the cord-shaped member 40 is coupled to each of the right-hand unit 20 and the left-hand unit 30 in a non-detachable manner, but the cord-shaped member 40 may be configured to be detachable by the user. This makes it possible to directly couple the right-hand unit 20 and the left-hand unit 30 with the cord-shaped member 40 detached or replace the cord-shaped member 40 with another. In particular, by replacing the cord-shaped member 40 with another cord-shaped member having a different length, it is possible to fix and use the operation device 10 with the information processing device 50 of any of various sizes.

Further, in the above description, the right-hand unit 20 and the left-hand unit 30 are each connected to the information processing device 50 by wireless communication. However, the configuration is not limited thereto, and the operation device 10 may be communicably connected to the information processing device 50 in a wired manner.

Specifically, in a case in which a receptacle such as a USB is disposed as a communication interface on one side surface of the information processing device 50, one of the right-hand unit 20 or the left-hand unit 30 may include a plug connector to be connected to this receptacle.

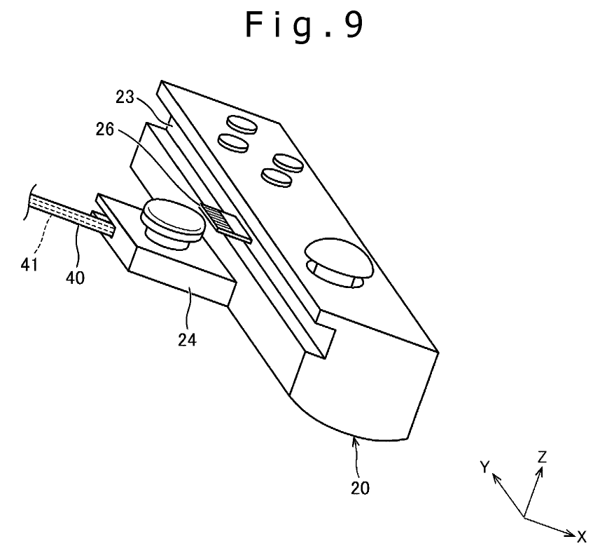

FIG. 9 is a diagram illustrating an example of a unit including such a plug connector. In the example of this drawing, a plug connector 26 is disposed on the surface of the right-hand unit 20. More specifically, the plug connector 26 is disposed so as to protrude from the surface of the abutment portion 23 that abuts against the information processing device 50, on the left-side surface of the right-hand unit 20, toward the information processing device 50 (negative side in X-axis direction). When the operation device 10 is fixed to the information processing device 50, this connector is inserted into a receptacle disposed on the right-side surface 54 of the information processing device 50, and both are connected. Accordingly, the right-hand unit 20 is communicably connected to the information processing device 50 in a wired manner and can transmit an operation signal or the like to the information processing device 50.

Further, by thus connecting the right-hand unit 20 and the information processing device 50 via the plug connector 26, it is possible to physically fix the right-hand unit 20 to the information processing device 50. Therefore, in this example, the abutment portion 23 need not necessarily have a U shape in a side view.

Furthermore, in this example, the left-hand unit 30 may be connected to the information processing device 50 by wireless communication as in the above description but may be connected to the right-hand unit 20 by wired communication. In this case, a signal line 41 for a wired communication connection is disposed inside the cord-shaped member 40. Note that, although the length of the cord-shaped member 40 varies due to the elastic force, by providing a margin to a length of the signal line 41 in the right-hand unit 20 and/or the left-hand unit 30, it is possible to prevent a physical load from being applied to the signal line 41, even when the length of the cord-shaped member 40 varies.

In this case, the left-hand unit 30 transmits an operation signal indicating the content of the operation input by the user to the operation member 31 to the right-hand unit 20 via the signal line 41 extending through the inside of the cord-shaped member 40. The right-hand unit 20 transmits the operation signal received from the left-hand unit 30, together with the operation signal indicating the content of the operation input by the user to the operation member 21 included therein to the information processing device 50 via the plug connector 26. Thus, even in a case in which the right-hand unit 20 and the left-hand unit 30 do not include a wireless communication interface, the operation device 10 can transmit an operation signal to the information processing device 50. Note that the wired connection by the plug connector 26 and the signal line 41 may be utilized not only for data communication but also for power supply.

Furthermore, in this example, the attachment 65 including a unique operation member such as illustrated in FIG. 7 may also include a receptacle, and the right-hand unit 20 may be coupled to the attachment 65 by inserting the plug connector 26 into this receptacle. In this way, the attachment 65 can transmit an operation signal indicating content of an operation input to an operation member such as the slide pad 66 included therein to the right-hand unit 20 via this plug connector 26. In this case, the attachment 65 need not include the wireless communication interface.

Further, in the above description, the cord-shaped member 40 is formed of a material that extends and contracts due to elasticity, but in a case in which a size of the corresponding information processing device 50 is determined in advance, need not necessarily extend and contract and may have a fixed length. Further, at least a portion of the cord-shaped member 40 may be wound and can be accommodated in the right-hand unit 20 or the left-hand unit 30. As a specific example, a reel or the like for winding the cord-shaped member 40 is built into the right-hand unit 20 and, in a state in which force is not applied by the user, at least a portion of the cord-shaped member 40 is accommodated in the unit. In this case, when the user applies a force in a direction in which the right-hand unit 20 and the left-hand unit 30 are separated from each other, the cord-shaped member 40 is pulled out from inside the right-hand unit 20, extending the length of a portion not accommodated in the right-hand unit 20. In this state, when the user engages the right-hand unit 20 and the left-hand unit 30 with the information processing device 50 and then releases their hands, a force for winding and accommodating the cord-shaped member 40 in the right-hand unit 20 is applied. Accordingly, the right-hand unit 20 and the left-hand unit 30 are pulled and fixed to the information processing device 50 by the force for winding the cord-shaped member 40, as in the case in which the cord-shaped member 40 itself extends and contracts due to elasticity.

### REFERENCE SIGNS LIST

10 Operation device, 20 Right-hand unit, 21 Operation member, 22 Communication interface, 23 Abutment portion, 24 Coupling portion, 26 Plug connector, 30 Left-hand unit, 31 Operation member, 32 Communication interface, 33 Abutment portion, 34 Coupling portion, 40 Cord-shaped member, 41 Signal line, 50 Information processing device, 51 Display screen, 60 Attachment, 61, 62 Fitting portion, 65 Attachment, 66 Slide pad.

What is claimed is:

1. An operation device comprising:
a right-hand unit that is configured to be gripped and used by a right hand of a user, and that includes an abutment portion that is configured to abut against one side surface of a mobile device;
a left-hand unit that is configured to be gripped and used by a left hand of a user, and that includes an abutment portion that is configured to abut against an opposite side surface of the mobile device to the one side surface; and
a cord member that is flexible and that is coupled to both the right-hand unit and the left-hand unit.

2. The operation device of claim 1, wherein the cord member is configured to extend and contract in length.

3. The operation device of claim 1, wherein the cord member applies a force that pulls the right-hand unit and the left-hand unit toward the mobile device when the right-hand unit and the left-hand unit are fixed to the mobile device.

4. The operation device of claim 1, wherein the abutment portion of the right-hand unit is configured to abut against the one side surface and a front surface of the mobile device on which the display screen is disposed.

5. The operation device of claim 4, wherein the abutment portion of the left-hand unit is configured to abut against the opposite side surface and the front surface of the mobile device on which the display screen is disposed.

6. The operation device of claim 1, wherein at least a portion of a surface of the abutment portion of the right-hand unit is formed of a member having a friction coefficient that is greater than a corresponding friction coefficient of other portions of a housing surface of the right-hand unit.

7. The operation device of claim 1, wherein at least a portion of a surface of the abutment portion of the left-hand unit is formed of a member having a friction coefficient that is greater than a corresponding friction coefficient of other portions of a housing surface of the left-hand unit.

8. The operation device of claim 1, wherein the right-hand unit and the left-hand unit each include a respective coupling mechanism that is configured to couple the right-hand unit directly to the left-hand unit.

9. The operation device of claim 1, wherein the coupling mechanisms of the right-hand unit and the left-hand unit couple the right-hand unit to the left-hand unit without either unit coupling to the mobile device.

10. The operation device of claim 1, wherein the respective abutment portion of at least one of the right-hand unit or the left-hand unit comprises a plug connector that is configured to be inserted into a receptacle disposed on the mobile device.

11. A method comprising:
providing a right-hand unit that is configured to be gripped and used by a right hand of a user, and that includes an abutment portion that is configured to abut against one side surface of a mobile device;
providing a left-hand unit that is configured to be gripped and used by a left hand of a user, and that includes an abutment portion that is configured to abut against an opposite side surface of the mobile device to the one side surface; and
providing a cord member that is flexible and that is coupled to both the right-hand unit and the left-hand unit.

12. The method of claim 11, wherein the cord member is configured to extend and contract in length.

13. The method of claim 11, wherein the cord member applies a force that pulls the right-hand unit and the left-hand unit toward the mobile device when the right-hand unit and the left-hand unit are fixed to the mobile device.

14. The method of claim 11, wherein the abutment portion of the right-hand unit is configured to abut against the one side surface and a front surface of the mobile device on which the display screen is disposed.

15. The method of claim 14, wherein the abutment portion of the left-hand unit is configured to abut against the opposite side surface and the front surface of the mobile device on which the display screen is disposed.

16. The method of claim 11, wherein at least a portion of a surface of the abutment portion of the right-hand unit is formed of a member having a friction coefficient that is greater than a corresponding friction coefficient of other portions of a housing surface of the right-hand unit.

17. The method of claim 11, wherein at least a portion of a surface of the abutment portion of the left-hand unit is formed of a member having a friction coefficient that is greater than a corresponding friction coefficient of other portions of a housing surface of the left-hand unit.

18. The method of claim 11, wherein the right-hand unit and the left-hand unit each include a respective coupling mechanism that is configured to couple the right-hand unit directly to the left-hand unit.

19. The method of claim 11, wherein the coupling mechanisms of the right-hand unit and the left-hand unit couple the right-hand unit to the left-hand unit without either unit coupling to the mobile device.

20. The method of claim 11, wherein the respective abutment portion of at least one of the right-hand unit or the left-hand unit comprises a plug connector that is configured to be inserted into a receptacle disposed on the mobile device.
